(19) United States
(12) Patent Application Publication
(10) Pub. No.: US 2023/0284345 A1
(43) Pub. Date: Sep. 7, 2023

(54) HEATING DEVICE FOR IMAGING DEVICE

(71) Applicant: NIFCO INC., Yokosuka-shi, Kanagawa (JP)

(72) Inventors: Daisuke MORI, Yokosuka-shi, Kanagawa (JP); Takahiro SAITO, Yokosuka-shi, Kanagawa (JP); Hiroshi OCHIAI, Yokosuka-shi, Kanagawa (JP)

(21) Appl. No.: 18/016,994

(22) PCT Filed: Jun. 30, 2021
(86) PCT No.: PCT/JP2021/024685

§ 371 Date: Jan. 19, 2023

(30) Foreign Application Priority Data
Jul. 22, 2020 (JP) 2020-125497

(51) Int. Cl. H05B 3/84; B60S 1/02; B60R 11/04; H04N 23/00

(52) U.S. Cl. CPC H05B 3/84; B60S 1/02; B60R 11/04; H04N 23/00; B60R 2011/0026

(57) ABSTRACT

A heating device for an imaging device is configured to heat a part of an attachment subject of the imaging device, and includes an opening portion located ahead of a light receiving portion that a camera unit has and opened along a direction away from the light receiving portion, and a heating section located on a side opposite to the attachment subject relative to the opening portion and having a sheet form. The heating section, in a view opposite to the opening portion relative to the attachment subject, at least overlaps a part of the opening portion, and in a portion of the opening portion where the heating section overlaps, in a width direction where the opening portion opens, a width of the heating section is greater than a width of the opening portion.

### FIELD OF THE INVENTION

The present invention relates to, for example, a heating device for an imaging device mounted on a window glass of a vehicle.

### BACKGROUND OF THE INVENTION

The imaging device for a vehicle is attached, for example, onto a surface on an inner side of a vehicle, in a pair of surfaces where a windshield glass has, as one example of a window glass. The imaging device is used to detect presence or absence of another vehicle and an obstacle located in front of own vehicle. The imaging device is provided with a bracket fixed to a windshield glass, a camera unit supported by the bracket, a light shielding hood defining a range of light that the camera unit receives, and a heating member fixed on a back side of the light shielding hood. The heating member makes water drops, frost and ice attached to a portion of the window glass due to condensation disappear by heating the portion of the window shield glass corresponding to the light shielding hood. Thereby, the imaging device can take a more clear image through the window glass (for example, Patent Document 1).

### PRIOR ART DOCUMENT

### Patent Document

Patent Document 1: Japanese Patent Publication No. 2017-185896.

### SUMMARY OF THE INVENTION

### Problems to be Solved by the Invention

By the way, the light shielding hood includes a bottom wall portion and two side wall portions. The bottom wall portion has, on a front side of the camera unit, approximately a triangular shape widening toward a direction away from the camera unit. Each side wall portion has a shape extending along a side in a direction away from the camera unit, and raises from the side. The heating member has a shape received within the bottom wall, and is fixed on a rear face of the bottom wall portion.

As stated above, since the imaging device receives light in a range defined by the light shielding hood, the imaging device receives light passing through a portion facing the light shielding hood in the wind shield. On the other hand, misalignment of the heating member relative to the bottom portion of the light shielding hood causes misalignment of a heated portion by the heating member in the windshield. Accordingly, since the misalignment of the heating member may have a fear of decreasing clarity of an image taken by the imaging device, high accuracy is required for positioning the heating member relative to the bottom wall. Since high accuracy required for positioning the heating member increases difficulty in the attachment of the heating member to the bottom wall, it is required that the heating member can be more easily attached.

It is an object of the invention to provide a heating device for an imaging device wherein a heading member can be attached more easily.

### Means for Solving the Problem

In one aspect of the disclosure, a heating device for an imaging device is configured to heat a part of an attachment subject of the imaging device, and comprises an opening portion located ahead of a light receiving portion that a camera unit has and widening along a direction away from the light receiving portion; and a heating section located on a side opposite to the attachment subject relative to the opening portion and having a sheet form. The heating section, in a view opposite to the opening portion relative to the attachment subject, at least overlaps a part of the opening portion, and in a portion of the opening portion where the heating section overlaps, in a width direction where the opening portion opens, a width of the heating section is greater than a width of the opening portion.

In one aspect of the disclosure, a heating device for an imaging device is configured to heat a part of an attachment subject of the imaging device, and comprises a plate shape portion which opens ahead of a light receiving portion that a camera unit has, and has a size corresponding to an image angle that the light receiving portion has; and a heating section located on a side opposite to the attachment subject relative to the plate shape portion and having a sheet form. The heating section, in a view opposite to the plate shape portion relative to the attachment subject, overlaps a part of the plate shape portion, and in a portion of the plate shape portion where the heating section overlaps, in a width direction where the plate shape portion opens, a width of the heating section is greater than a width of the plate shape portion.

### BRIEF DESCRIPTION OF THE DRAWINGS

FIG. 1 is a perspective view showing a structure where an imaging device for a vehicle in one embodiment is disassembled.

FIG. 2 is a perspective view showing a structure where the imaging device for the vehicle shown in FIG. 1 is assembled.

FIG. 3 is a plan view showing a structure where the imaging device for the vehicle shown in FIG. 2 is seen from a point facing a front face of a bracket main body.

### EMBODIMENTS TO IMPLEMENT THE INVENTION

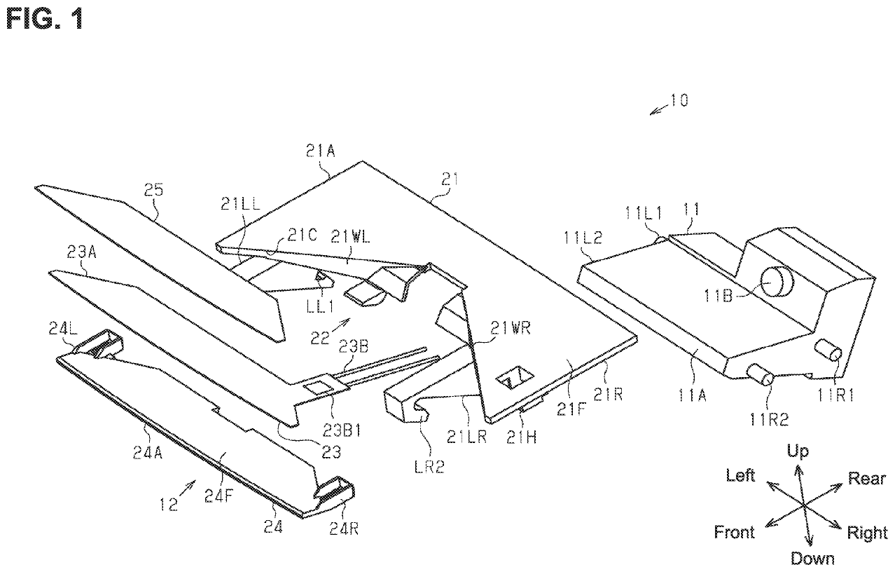

With reference to FIGS. 1 to 3, an embodiment of a heating device for an imaging device is explained.

An imaging device 10 for a vehicle as shown in FIG. 1 is attached to an attachment subject, and receives light incident through the attachment subject. The attachment subject is a transparent member having a light transmissibility through which visible light passes, and is, for example, a window glass of a vehicle. The imaging device 10 is attached to an inner surface of the window glass with a pair of faces, on a side of a vehicle compartment. The window glass is, for example a windshield glass, but it may be a sunroof glass and a rear window glass. The imaging device 10 is provided with a camera unit 11 and a heating device 12.

The camera unit 11 is provided with a camera main body 11A, and a lens 11B, which is an example of a light receiving member. The camera main body 11A is provided with, for example imaging elements, recording elements, a housing retaining these elements, and so on. The lens 11B is exposed outside of the camera main body 11A, and receives light incident through the attachment subject.

The heating device 12 heats a part of the attachment subject of the imaging device 10 in a condition that the imaging device 10 is attached to the attachment subject. The heating device 12 is provided with an opening portion 22 and a heating section 23. The opening portion 22 is located ahead of the lens 11B which is provided in the camera unit 11, and opens widely along a direction away from the lens 11B. The heating section 23 is located on a side opposite to the attachment subject relative to the opening portion 22, and has a sheet form. The heating section 23 overlaps at least a part of the opening portion 22 from a view opposite to a side of the opening 22 relative to the attachment subject, and at a portion overlapping with the heating section 23 in the opening portion 22, in a width direction where the opening portion 22 opens, the width of the heating section 23 is greater than a width of the opening portion.

Thus, in a view opposite to the opening portion 22 relative to the attachment subject, in the width direction where the opening portion 22 opens, the width of the heating section 23 is wider than the opening portion 22. Thus, even if the location of the heating section 23 relative to the opening portion 22 is deviated in the width direction, if the deviation is within a difference between a size of the opening portion 22 and a size of the heating section 23, an entire exposed portion exposed to the opening portion 22 including the imaging subject of the camera unit 11 is a subject to be heated by the heating section 23. Namely, for a difference between the size of the opening portion 22 and the size of the heating section 23, deviation of the location of the heating section 23 relative to the opening portion 22 is permitted. Accordingly, an attachment of the heating section 23 is made easier.

Hereinbelow, respective members where the imaging device 10 is provided are explained with reference to FIG. 1.

The camera main body 11A that the camera unit 11 is provided has an outer shape where a cross sectional shape with about L shape continues along a left-right direction of the imaging device 10. The camera unit 11 is provided with a first right engagement portion 11R1, a second right engagement portion 11R2, a first left engagement portion 11L1, and a second left engagement portion 11L2. A pair of right engagement portions 11R1, 11R2 has a columnar shape projecting along the left-right direction from the right side face of the camera main body. A pair of left engagement portions 11L1, 11L2 has a columnar shape projecting along the left-right direction from the left side of the camera main body 11A. The pair of first engagement portions 11R1, 11L1 extends along the same center axis line. The pair of second engagement portions 11R2, 11L2 extends along the same center axis at a position different from the first engagement portions 11R1, 11L1. The pair of second engagement portions 11R2. 11L2 is located ahead of the pair of first engagement portions 11R1, 11L1.

The heating device 12 is provided with a bracket 21. The bracket 21 is attached to the attachment subject by an attachment member, such as an adhesive, a connecting member and so on. The bracket 21 is a resin molded product molded by resin. The bracket 21 is provided with a bracket main body 21A having approximately a rectangular plate shape. The bracket main body 21A includes an outer face 21F, and a rear face 21R opposite to the outer face 21F. The outer face 21F of the bracket main body 21A is arranged along the attachment subject in case the imaging device 10 is attached. The bracket main body 21A has about a V-shape notch 21C on a front edge extending along the left-right direction.

In the notch 21C, a right wall portion 21WR and a left wall portion 21WL, extending downwardly, are disposed. The right wall portion 21WR and the left wall portion 21WL sandwich the lens 11B, and are examples of a pair of wall portions defining the opening portion 22 from the outside of the opening 22. Since a part of light incident to the opening portion 22 from the outside of the opening portion 22 is shielded by the wall portions 21WR, 21WL, an excess amount of light entering into the opening portion 22 is suppressed. Thereby, degrading of the image quality due to excess light is suppressed.

The pair of wall portions 21WR, 21WL is located in the center of the notch 21C and sandwiches a portion where the lens 11B of the camera unit 11 is arranged, along the left-right direction. The right wall portion 21WR has a shape extending toward a right end from a center of the notch 21C along the notch 21C. The left wall portion 21WL has a shape extending toward a left end from the center of the notch 21C along the notch 21C. In the present embodiment, from a view facing the surface 21F of the bracket main body 21A, an area surrounded by the pair of wall portions 21WR, 21WL and having an approximately V-shape located ahead of the lens 11B is the opening portion 22. Thus, the width direction where the opening portion 22 opens is equal to the left-right direction.

The bracket 21 is provided with a right engagement leg 21LR and a left engagement leg LL. Each of the engagement legs 21LR, 21LL is connected to the rear face 21R. Each of the legs 21LR, 21LL has a shape extending in the front-back direction, and a part of each of the engagement legs 21LR, 21LL exposes from the notch 21C.

The right engagement leg 2LR includes a first right engagement groove which is not shown, and a second right engagement groove LR2. The left engagement leg 21LL includes a first left engagement groove LL1, and a second left engagement groove which is not shown. The pair of first engagement grooves is located on a same axis line extending in the left-right direction. The pair of second engagement grooves is located on the same axis line extending in the left-right direction. The pair of second engagement grooves LR2 is located ahead of the pair of first engagement grooves.

When the vehicle imaging device 10 is assembled, the first right engagement portion 11R1 is fitted into the first right engagement groove, and the first left engagement portion 11L1 is fitted into the first left engagement groove LL1. Also, the second right engagement portion 11R2 is fitted into the second right engagement groove LR2, and the second left engagement portion 11L2 is fitted into the second left engagement groove. Thereby, the bracket 21 supports the camera unit 11.

The bracket further includes a hood engagement portion 21H. The hood engagement portion 21H is connected to a rear face 21R of the bracket main body 21A. In the hood engagement portion 21H, a section along a plane defined by the up-down direction and the left-right direction has approximately an inverted C-shape. The hood engagement portion 21H has a shape such that the sections with the inverted C-shape continue successively along a front-back direction.

The bracket 21 includes a hood engagement groove, not shown. The hood engagement groove is formed by a left engagement leg 21LL and the bracket main body 21A.

The heating device 12 further includes a lens hood 24. The lens hood 24 is, as in the bracket 21 explained before, a resin molded product molded by a resin. The lens hood 24 includes a hood main body 24A, a right engagement projection 24 R, and a left engagement projection 24L. The hood main body 24A has approximately a trapezoidal shape. A face facing the heating section 23 in a pair of faces facing each other in the hood main body 24A is a front face 24F. The front face 24F is a face where the heating section 23 is arranged.

The right engagement projection 24R has a shape located at a right end of the hood main body 24A and extending along the front-rear direction. The left engagement projection 24L has a shape located at a left end of the hood main body 24A and extending along the front-rear direction. When the vehicle imaging device 10 is assembled, the lens hood 24 is supported on the bracket 21 by inserting the right engagement projection 24R into the hood engagement portion 21H and inserting the left engagement projection 24L into the hood engagement groove. Thus, the right engagement projection 24 and the left engagement projection 24L allow the hood main body 24A to engage with the bracket 21 by the engagement with the bracket 21.

The heating section 23 includes a heat generation portion 23A and a supply part 23B. The heat generation portion 23A has approximately a trapezoidal shape. In the left-right direction, a width of the heat generation portion 23A is generally equal to a width of the hood main body 24A. In the front-rear direction, a width of the heat generation portion 23A is generally a width equal to the hood main body 24A. A subject area that the heat generation portion 23A heats has generally a shape and a size same as an outer shape of the heat generation portion 23A. In the width direction, the heating section 23 is equal to the width of the heat generation portion 23A.

The heat generation portion 23A may be, for example, a plane type heat generation member. The heat generation portion 23A includes, for example, a plane good heat conductor, an electrification portion and a pair of heat insulation films. The electrification portion is formed by one heating line, and is connected to a supply part 23B. The electrification portion is sandwiched between the pair of insulation films. The plane heat conductor is stuck on one of the insulating films.

The supply part 23B is electrically connected to the heat generation portion 23A to supply current to the heat generation portion 23A. The supply part 23B includes a protection circuit 23B1. The protection circuit 23B1 suppresses a magnitude of the current flowing through the plane type heat generation member within a predetermined range. The protection circuit 23B1 includes a temperature fuse. The supply part 23B is connected to a right end of the heat generation portion 23A, and has a shape extending along the front-rear direction.

The heat generation portion 23A is fitted onto the front face 24F of the hood main body 24A by a sticking material, adhesive material and so on.

The heating device 12 further includes a reflection suppressing sheet 25. The reflection suppressing sheet 25 has generally a trapezoidal shape. In the left-right direction, a width of the reflection suppressing sheet 25 is generally equal to a width of the heat generation portion 23A. In the front-read direction, a width of the reflection suppressing sheet 25 is substantially equal to the width of the heat generation portion 23A. The reflection suppressing sheet 25 covers a whole heat generation portion 23A.

The reflection suppressing sheet 25 is, for example a film made of a resin. The reflection suppressing sheet 25 suppresses reflection of light by, for example absorbing light incident to the reflection suppressing sheet 25. In case the reflection suppressing sheet absorbs light incident to the reflection suppressing sheet 25, the reflection suppressing sheet 25 is, for example black. The reflection suppressing sheet 25 is fitted onto the heating section 23 by, for example a sticking material, adhesive material and so on.

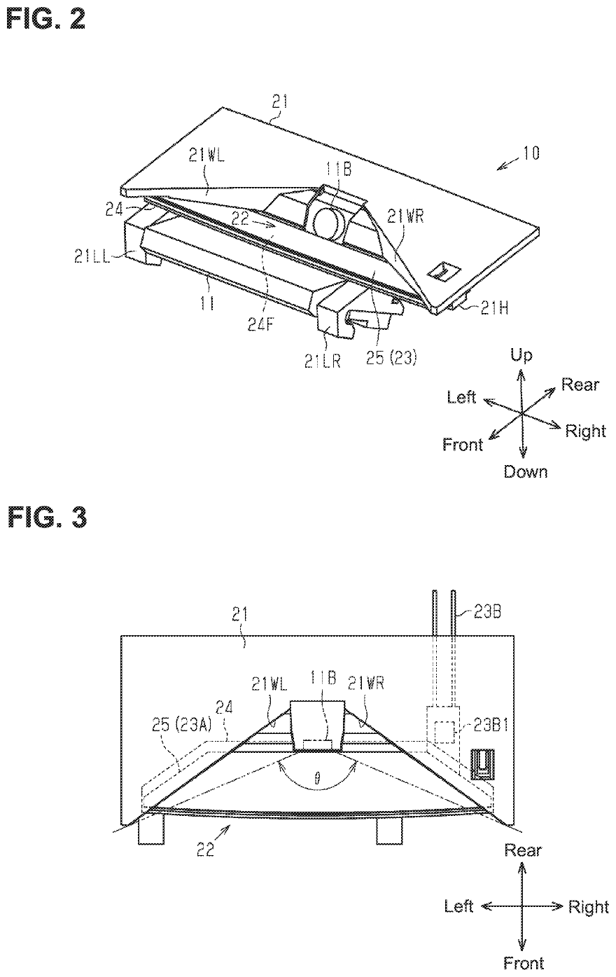

FIG. 2 shows a condition such that the vehicle imaging device 10 is assembled.

As shown in FIG. 2, in the vehicle imaging device 10 assembled, the camera unit 11 is supported by the pair of engagement upper legs 21LR, 21LL. In the vehicle imaging device 10, the lens hood 24 to which the heating section 23 and the reflection suppressing sheet 25 are attached is supported by the hood engagement portion 21H that the bracket has, and the hood engagement groove.

In the vehicle imaging device 10, the lens 11B of the camera unit 11 is arranged between the pair of wall portions 21WR, 21WL in the left-right direction. Thereby, the lens 11B exposes to the opening portion 22. In the vehicle imaging device 10, among light incident to the vehicle compartment through the attachment subject, an area surround by the pair of wall portions 21WR, 21WL and the lens hood 24, namely, only light which can enter the opening portion 22, enters the lens 11B. At this time, the incident light directed to the lens hood 24 is absorbed by the reflection suppressing sheet 25 attached on the surface 24F of the lens hood 24, and the heating section 23. Thereby, since the light reflected by the lens hood 24 does not substantially enter the lens 11B, lowering of the quality of the image taken by the camera unit 11 is suppressed.

FIG. 3 shows a structure of the vehicle imaging device 10 in a view facing the front face of the bracket 21 in the condition where the vehicle imaging device 10 is assembled. Incidentally, in FIG. 3, for the sake of showing in the drawing, the camera unit 11 is omitted.

As shown in FIG. 3, in a view opposite to the opening portion 22 relative to the attachment subject, the opening portion 22 is defined by the pair of wall portions 21WR, 21WL and a portion sandwiched by the pair of wall portions 21WR, 21WL within the reflection suppressing sheet 25. Thereby, since the heating section 23 is covered by the reflection suppressing sheet 25, the reflection of light by the heating section 23 is suppressed. Accordingly, lowing of the quality of image due to the reflection at the heating section 23 is suppressed.

In the view opposite to the opening portion 22 relative to the attachment subject, the width of the heat generation portion 23A is greater than the width of the opening portion 22 in the left-right direction where the opening portions 22 opens. Thus, in the view opposite to the opening portion 22 relative to the attachment subject, the supply portion 23B connected to the right end of the heat generation portion 23A is located outside relative to the opening portion 22. Accordingly, the protection circuit 23B provided in the supply portion 23B is also located outside the opening portion 22. In other words, in the view opposite to the opening portion 22 relative to the attachment subject, the protection circuit 23B1 is covered by the bracket 21.

Since the protection circuit 23B1 is located outside the opening portion 22, in comparing with a case where the protection circuit 23B1 is located in the opening portion 22, lowing of quality of image due to the situation that the protection circuit 23B1 faces the attachment subject is suppressed.

Incidentally, the heating device 12 is also a structure having a plate shape portion and the heating section. The plate shape portion opens toward a from side of the leans 11B that the camera unit 11 has, and has a size corresponding to an image angle θ that the lens 11B has. The heating section 23 is located opposite to the attachment subject relative to the plate shape portion, and has a sheet shape. In a view opposite to the plate shape portion relative to the attachment subject, the heating section 23 overlaps a part of the plate shape portion. In the plate shape portion where it is overlapped with the heating section 23, the width of the heating section 23 is greater than the width of the plate shape portion in the width direction where the plate shape portion opens.

In a view opposite to the plate shape portion relative to the attachment subject, the width of the heating section 23 is greater than the width of the plate shape portion in the width direction where the opening portion 22 opens. Thus, even if a location of the heating section 23 relative to the plate shape portion in the width direction is deviated, in case the deviation is within a difference between the size of the plate shape portion and the size of the heating section 23, in the attachment subject, the whole portion exposed to the plate shape portion including the imaging subject of the camera unit 11 is the subject to be heated by the heating section 23. Namely, the deviation of the heating section 23 relative to the plate shape portion is permitted for the difference between the size of the plate shape portion and the size of the heating section 23. Accordingly, an attachment of the heating section 23 can be made easy.

A range corresponding to the image angle θ, in a view opposite to the plate shape portion relative to the attachment subject, is a range overlapping the image angle θ of the lens 11B. In the present embodiment, it is an area sandwiched by the pair of two dotted chain line shown in FIG. 3. Namely, in the reflection suppression sheet 25, a portion sandwiched by the pair of two dotted chain lines is the plate shape portion. Thus, since a part of the reflection suppression sheet 25 functions as the plate shape portion having a size corresponding to the image angle θ, the light reflected by the plate shape portion is suppressed to enter the lens 11B. Accordingly, an excessive light does not enter the lens 11B.

As explained above, in one embodiment of the heating device for the imaging device, the following advantages are obtained.
(1) For the difference between the size of the opening portion 22 and the size of the heating section 23, deviation of the position of the heating section 23 relative to the opening portion 22 is permitted. Accordingly, an attachment of the heating section 23 can be made easily.
(2) Since a part of light entering into the opening portion 22 from the outside of the opening portion 22 is shielded by the pair of wall portions 21WR, 21WL, it is possible to suppress the excess amount of light entering into the opening portion 22. Accordingly, lowing of the image quality due to the excess amount of light can be suppressed.
(3) Since the heating section 23 is covered by the reflection suppression sheet 25, reflection of light at the heating section 23 can be suppressed. Accordingly, lowing of the image quality due to the reflection at the heating section 23 can be suppressed.
(4) Since the protection circuit 23B1 is located outside the opening portion 22, in comparing with a situation where the protection circuit 23B1 is located in the opening portion 22, lowing of the image quality due to a situation where the protection circuit 23B1 faces the attachment subject in the lens hood 24 can be suppressed.
(5) For the difference between the size of the plate shape portion and the size of the heating section 23, deviation of the location of the heating section 23 relative to the plate shape portion is permitted. Accordingly, an attachment of the heating section 23 can be made easy.
(6) Since the portion of the reflection suppression sheet 25 functions as the plate shape portion having a size corresponding to the image angle θ, entering of the light reflexed at the plate shape portion into the lens 11B is suppressed. Accordingly, entering of excess light relative to the lens 11B is suppressed.

Incidentally, the embodiment explained above can be modified.

[Reflection Suppression Sheet]

In case the reflection suppression sheet 25 has a size corresponding to the image angle θ, the reflection suppression sheet 25 is the plate shape portion. In this case, in a view opposite to the reflection suppression sheet 25 relative to the attachment subject, in the width direction, by the situation where the width of the heating section 23 is greater than the width of the plate shape portion, the advantages similar to the above (1) can be obtained.

The reflection suppression sheet 25 need not be limited to a sheet suppressing reflection of light incident to the lens hood 24 by the light absorption, and for example, it may be a sheet suppressing light reflection incident to the lens hood 24 by passing of light. The sheet suppressing reflection of light by passion of light, may be a sheet having a moth-eye structure. Accordingly, since the reflection of light incident to the lens hood 24 is suppressed, the advantages similar to the above (3) and (6) are obtained.

The heating device 12 may not have the reflection suppression sheet. Even in the case, in a portion overlapping with the heating section 23 in the opening portion 22, in the width direction where the opening portion 22 opens, the width of the heating section 23 is greater than the width of the opening portion 22, so that the advantage similar to the above (1) can be obtained.

[Heating Section]

The protection circuit 23B1 may be located in the opening portion 22. Even in this case, in case the heating section 12 includes the reflection suppression sheet 25, the protection circuit 23B1 is covered by the reflection sheet 25, so that lowing of the image quality can be suppressed.

Incidentally, in case the protection circuit 23B1 is located in the opening portion 22, the lens hood 24 may have a dent dented from the surface 24 F of the lens hood 24, and the protection circuit 23B1 may be located in the dent. In this case, it is preferable that the depth of the dent is greater than the thickness of the protection circuit 23B1. Accordingly, it is possible to suppress that a part of the reflection sheet 25 has a projection due to the protection circuit 23B1, and prevention of taking an image by the projection due to the protection circuit 23B1 is suppressed.

The heating section 23 may be located, in the lens hood 24, in a face opposite to the face facing the attachment subject. Namely, the heating section 23 may be located on the rear face opposite to the front face 24F of the lens hood 24. In this case, if the protection circuit 23B1 is located in the opening portion 22, since the protection circuit 23B1 is covered by the lens hood 24, so that lowing of the image quality due to the location of the protection circuit 23B1 is suppressed. Also, in this case, if the heating device 12 does not have the reflection suppression sheet 25, reflection of light due to the heating section 23 does not occur.

The heating section 23 overlaps, in a view opposite to the opening 22 relative to the attachment subject, the whole of the opening portion 22. In this case, in the width direction where the opening portion 22 opens, the width of the heating section 23 is greater than the width of the opening portion 22, so that the advantages similar to the (1) is obtained.

The width of the heating section 23 may be greater than the width of the opening 22 in the direction crossing the width direction where the opening portion 22 opens. in addition to the width direction where the opening portion 22 opens. For example, in the above embodiment, in the front-rear direction, the width of the heating section 23 may be greater than the width of the opening portion 22. In this case, in the front-rear direction, for the difference between the width of the heating section 23 and the width of the opening portion 22, deviation of the location of the heating section 23 relative to the opening portion is permitted.

[Lens Hood]

In case the heating section 23 is sufficiently high in mechanical strength, the heating device 12 may not have a lens hood 24 for supporting the heating device 23. In this case, in the width direction where the opening portion 22 opens, the width of the heating section 23 is greater than the width of the opening portion 22, so that the above (1) can be obtained.

[Bracket]

The bracket 21 may not have the pair of wall portion 21WR, 21WL. In this case, the opening portion 22 may be an area in front of the lens 11B and an area with approximately V-shape defined by the notch 21C where the bracket main body 21A has. In this case, in the width direction where the opening portion 22 opens, the width of the heating section 23 is greater than the width of the opening 22, so that the advantages corresponding to the above (1) can be obtained.

The bracket main body 21A may not have the notch 21C. Namely, in a view facing the front face 21F, the bracket main body 21A may have an approximately rectangular shape. In this case, the opening portion 22 is divided, instead of the pair of wall portions 21WR, 21WL, by the two ends in the left-right direction of the reflection suppression sheet 25 from the outside of the opening portion 22. And in this case, in the direction where the opening portion 22 opens, the width of the heating section 23 is greater than the width of the opening portion 23, so that the advantages corresponding to the above (1) is obtained.

[Camera Unit]

The camera unit 11 may have more than two lenses 11B. In this case, the heating device 12 may have an opening portion and a heating section individually for each lens 11B, or have an opening portion and a heating section applied to the plurality of lenses 11B. In this case, in the width direction where the opening portion 22 opens, the width of the heating section is greater than the width of the opening portion 22, so that the advantages corresponding to the above (1) are obtained.

The camera unit 11 may have a light receiving portion apart from the lens 11B. For example, the light receiving portion may be a transparent film which can project an image of the subject. In this case, in the width direction where the opening portion 22 opens, the width of the heating section 23 is greater than the opening portion 22, so that the advantages corresponding to the above (1) are obtained.

1. A heating device for an imaging device configured to heat a part of an attachment subject of the imaging device, comprising:
an opening portion located ahead of a light receiving portion that a camera unit has, and opened along a direction away from the light receiving portion, and
a heating section located on a side opposite to the attachment subject relative to the opening portion and having a sheet form,
wherein the heating section, in a view opposite to the opening portion relative to the attachment subject, at least overlaps a part of the opening portion, and in a portion of the opening portion where the heating section overlaps, in a width direction where the opening portion opens, a width of the heating section is greater than a width of the opening portion.

2. A heating device for an imaging device according to claim 1, further comprising a pair of wall portions which sandwiches the light receiving portion in the width direction and defines the opening portion from an outside of the opening portion.

3. A heating device for an imaging device according to claim 1, wherein
the heating section includes a protection circuit, and
the protection circuit is located outside the opening portion in a view opposite to the opening portion relative to the attachment subject.

4. A heating device for an imaging device according to claim 1, further comprising:
a reflection suppression sheet covering the heating section and having a reflection rate, relative to a visible light, lower than the heating section.

5. A heating device for an imaging device configured to heat a part of an attachment subject of the imaging device, comprising:
a plate shape portion which opens ahead of a light receiving portion that a camera unit has, and having a size corresponding to an image angle that the light receiving portion has, and
a heating section located on a side opposite to the attachment subject relative to the plate shape portion and having a sheet form,
wherein the heating section, in a view opposite to the plate shape portion relative to the attachment subject, overlaps a part of the plate shape portion, and in a portion of the plate shape portion where the heating section overlaps, in a width direction where the plate shape portion opens, a width of the heating section is greater than a width of the plate shape portion.

6. A heating device for an imaging device according to claim 5, further comprising:
a reflection suppression sheet covering the heating section and having a reflection rate, relative to a visible light, lower than the heating section,
wherein the plate shape portion is a part of the reflection suppression sheet.
